(19) United States
(12) Patent Application Publication
(10) Pub. No.: US 2026/0138996 A1
(43) Pub. Date: May 21, 2026

(54) SYNTHESIS OF ALUMINUM PRECURSORS WITHOUT USE OF PYROPHORIC COMPOUNDS AND RELATED COMPOSITIONS AND RELATED METHODS

(71) Applicant: ENTEGRIS, INC., Billerica, MA (US)

(72) Inventor: Drew Michael Hood, Newtown, CT (US)

(21) Appl. No.: 19/391,894

(22) Filed: Nov. 17, 2025

Related U.S. Application Data
(60) Provisional application No. 63/722,448, filed on Nov. 19, 2024.

(51) Int. Cl. C07F 5/06

(52) U.S. Cl. CPC C07F 5/066

(57) ABSTRACT

Methods for forming a vapor deposition precursor are provided. The method comprises contacting an aluminum halide compound, an alkoxy aluminum compound, and a Grignard reagent to form the vapor deposition precursor. The vapor deposition precursor comprises an dialkyl aluminum alkoxide compound. The vapor deposition precursor is formed without use of a pyrophoric compound. Related compositions, related precursors, and related methods are also provided, among other things.

### CROSS-REFERENCE TO RELATED APPLICATIONS

This application claims the benefit under 35 USC 119 of U.S. Provisional Patent Application No. 63/722,448, filed Nov. 19, 2024, the disclosure of which is hereby incorporated herein by reference in its entirety.

### FIELD

The present disclosure relates to synthesis of aluminum precursors without use of pyrophoric compounds and related compositions and related methods.

### BACKGROUND

Conventional methods for synthesizing aluminum precursors can present dangerous conditions due to the reagents used and the reaction conditions employed.

### SUMMARY

Some embodiments relate to a method. In some embodiments, the method comprises contacting at least of an aluminum halide compound, an alkoxy aluminum compound, and a Grignard reagent to form a vapor deposition precursor. In some embodiments, the vapor deposition precursor comprises a dialkyl aluminum alkoxide compound.

Some embodiments relate to a method. In some embodiments, the method comprises contacting at least a solution comprising an aluminum halide compound with an alkoxy aluminum compound to form a first product. In some embodiments, the method comprises contacting at least the first product with a Grignard reagent to form a second product comprising a vapor deposition precursor.

Some embodiments relate to a method. In some embodiments, the method comprises dissolving at least an aluminum halide compound in a solvent to form a solution comprising the aluminum halide compound. In some embodiments, the method comprises contacting at least the solution with an alkoxy aluminum compound to form a first product. In some embodiments, the method comprises contacting at least the first product with a Grignard reagent to form a second product comprising a vapor deposition precursor.

Some embodiments relate to a composition. In some embodiments, the composition comprises at least 99% by weight of a vapor deposition precursor based on a total weight of the composition. In some embodiments, the vapor deposition precursor comprises a dialkyl aluminum alkoxide compound.

### BRIEF DESCRIPTION OF THE DRAWINGS

FIG. 1 is a flowchart of a method for synthesizing a precursor, according to some embodiments.

FIG. 2 is a flowchart of a method for making a film, according to some embodiments.

FIG. 3 is a schematic diagram of a reaction scheme for synthesizing a precursor, according to some embodiments.

### DETAILED DESCRIPTION

As used herein, the term “alkyl” refers to a hydrocarbyl having from 1 to 30 carbon atoms. The alkyl may be attached via a single bond. An alkyl having n carbon atoms may be designated as a “Cₙ alkyl.” For example, a “C₃ alkyl” may include n-propyl and isopropyl. An alkyl having a range of carbon atoms, such as 1 to 30 carbon atoms, may be designated as a C₁-C₃₀ alkyl. In some embodiments, the alkyl is linear. In some embodiments, the alkyl is branched. In some embodiments, the alkyl is substituted. In some embodiments, the alkyl is unsubstituted. In some embodiments, the alkyl comprises or is selected from the group consisting of at least one of a C₁-C₃₀ alkyl, C₁-C₂₉ alkyl, C₁-C₂₈ alkyl, C₁-C₂₇ alkyl, C₁-C₂₇ alkyl, C₁-C₂₆ alkyl, C₁-C₂₅ alkyl, C₁-C₂₄ alkyl, C₁-C₂₃ alkyl, C₁-C₂₂ alkyl, C₁-C₂₁ alkyl, C₁-C₂₀ alkyl, C₁-C₁₉ alkyl, C₁-C₁₈ alkyl, C₁-C₁₇ alkyl, C₁-C₁₆ alkyl, C₁-C₁₅ alkyl, C₁-C₁₄ alkyl, C₁-C₁₃ alkyl, C₁-C₁₂ alkyl, C₁-C₁₁ alkyl, C₁-C₁₀ alkyl, a C₁-C₉ alkyl, a C₁-C₈ alkyl, a C₁-C₇ alkyl, a C₁-C₆ alkyl, a C₁-C₅ alkyl, a C₁-C₄ alkyl, a C₁-C₃ alkyl, a C₁-C₂ alkyl, a C₂-C₃₀ alkyl, a C₃-C₃₀ alkyl, a C₄-C₃₀ alkyl, a C₅-C₃₀ alkyl, a C₆-C₃₀ alkyl, a C₇-C₃₀ alkyl, a C₈-C₃₀ alkyl, a C₉-C₃₀ alkyl, a C₁₀-C₃₀ alkyl, a C₁₁-C₃₀ alkyl, a C₁₂-C₃₀ alkyl, a C₁₃-C₃₀ alkyl, a C₁₄-C₃₀ alkyl, a C₁₅-C₃₀ alkyl, a C₁₆-C₃₀ alkyl, a C₁₇-C₃₀ alkyl, a C₁₈-C₃₀ alkyl, a C₁₉-C₃₀ alkyl, a C₂₀-C₃₀ alkyl, a C₂₁-C₃₀ alkyl, a C₂₂-C₃₀ alkyl, a C₂₃-C₃₀ alkyl, a C₂₄-C₃₀ alkyl, a C₂₅-C₃₀ alkyl, a C₂₆-C₃₀ alkyl, a C₂₇-C₃₀ alkyl, a C₂₈-C₃₀ alkyl, a C₂₉-C₃₀ alkyl, a C₂-C₁₀ alkyl, a C₃-C₁₀ alkyl, a C₄-C₁₀ alkyl, a C₅-C₁₀ alkyl, a C₆-C₁₀ alkyl, a C₇-C₁₀ alkyl, a C₈-C₁₀ alkyl, a C₂-C₉ alkyl, a C₂-C₈ alkyl, a C₂-C₇ alkyl, a C₂-C₆ alkyl, a C₂-C₅ alkyl, a C₃-C₅ alkyl, or any combination thereof. In some embodiments, the alkyl comprises or is selected from the group consisting of at least one of methyl, ethyl, n-propyl, 1-methylethyl (iso-propyl), n-butyl, iso-butyl, sec-butyl, n-pentyl, 1,1-dimethylethyl (t-butyl), n-pentyl, iso-pentyl, n-hexyl, isohexyl, 3-methylhexyl, 2-methylhexyl, heptyl, octyl, nonyl, decyl, dodecyl, octadecyl, or any combination thereof. In some embodiments, the term “alkyl” refers generally to alkyls, alkenyls, alkynyls, and/or cycloalkyls.

As used herein, the term “alkenyl” refers to a hydrocarbyl having from 1 to 30 carbon atoms and at least one carbon-carbon double bond. In some embodiments, the alkenyl comprises or is selected from the group consisting of at least one of a C₁-C₃₀ alkenyl, C₁-C₂₉ alkenyl, C₁-C₂₈ alkenyl, C₁-C₂₇ alkenyl, C₁-C₂₇ alkenyl, C₁-C₂₆ alkenyl, C₁-C₂₅ alkenyl, C₁-C₂₄ alkenyl, C₁-C₂₃ alkenyl, C₁-C₂₂ alkenyl, C₁-C₂₁ alkenyl, C₁-C₂₀ alkenyl, C₁-C₁₉ alkenyl, C₁-C₁₈ alkenyl, C₁-C₁₇ alkenyl, C₁-C₁₆ alkenyl, C₁-C₁₅ alkenyl, C₁-C₁₄ alkenyl, C₁-C₁₃ alkenyl, C₁-C₁₂ alkenyl, C₁-C₁₁ alkenyl, C₁-C₁₀ alkenyl, a C₁-C₉ alkenyl, a C₁-C₈ alkenyl, a C₁-C₇ alkenyl, a C₁-C₆ alkenyl, a C₁-C₅ alkenyl, a C₁-C₄ alkenyl, a C₁-C₃ alkenyl, a C₁-C₂ alkenyl, a C₂-C₃₀ alkenyl, a C₃-C₃₀ alkenyl, a C₄-C₃₀ alkenyl, a C₅-C₃₀ alkenyl, a C₆-C₃₀ alkenyl, a C₇-C₃₀ alkenyl, a C₈-C₃₀ alkenyl, a C₉-C₃₀ alkenyl, a C₁₀-C₃₀ alkenyl, a C₁₁-C₃₀ alkenyl, a C₁₂-C₃₀ alkenyl, a C₁₃-C₃₀ alkenyl, a C₁₄-C₃₀ alkenyl, a C₁₅-C₃₀ alkenyl, a C₁₆-C₃₀ alkenyl, a C₁₇-C₃₀ alkenyl, a C₁₈-C₃₀ alkenyl, a C₁₉-C₃₀ alkenyl, a C₂₀-C₃₀ alkenyl, a C₂₁-C₃₀ alkenyl, a C₂₂-C₃₀ alkenyl, a C₂₃-C₃₀ alkenyl, a C₂₄-C₃₀ alkenyl, a C₂₅-C₃₀ alkenyl, a C₂₆-C₃₀ alkenyl, a C₂₇-C₃₀ alkenyl, a C₂₈-C₃₀ alkenyl, a C₂₉-C₃₀ alkenyl, a C₂-C₁₀ alkenyl, a C₃-C₁₀ alkenyl, a C₄-C₁₀ alkenyl, a C₅-C₁₀ alkenyl, a C₆-C₁₀ alkenyl, a C₇-C₁₀ alkenyl, a C₈-C₁₀ alkenyl, a C₂-C₈ alkenyl, a C₂-C₈ alkenyl, a C₂-C₇ alkenyl, a C₂-C₆ alkenyl, a C₂-C₅ alkenyl, a C₃-C₅ alkenyl, or any combination thereof. Examples of alkenyl groups include, without limitation, at least one of vinyl, allyl, 1-methylvinyl, 1-propenyl, 1-butenyl, 2-butenyl, 3-butenyl, 1,3-butadienyl, 2-methyl-1-propenyl, 2-methyl-2-propenyl, 1-pentenyl, 2-pentenyl, 3-pentenyl, 4-pentenyl, 1,3-pentadienyl, 2,4-pentadienyl, 1,4-pentadienyl, 3-methyl-2-butenyl, 1-hexenyl, 2-hexenyl, 3-hexenyl, 1,3-hexadienyl, 1,4-hexadienyl, 2-methylpentenyl, 1-heptenyl, 3-heptenyl, 1-octenyl, 1,3-octadienyl, 1-nonenyl, 2-nonenyl, 3-nonenyl, 1-decenyl, 3-decenyl, 1-undecenyl, oleyl, linoleyl, linolenyl, or any combination thereof.

As used herein, the term “alkynyl” refers to a hydrocarbyl having from 1 to 30 carbon atoms and at least one carbon-carbon triple bond. In some embodiments, the alkynyl comprises or is selected from the group consisting of at least one of a C₁-C₃₀ alkynyl, C₁-C₂₉ alkynyl, C₁-C₂₈ alkynyl, C₁-C₂₇ alkynyl, C₁-C₂₇ alkynyl, C₁-C₂₆ alkynyl, C₁-C₂₅ alkynyl, C₁-C₂₄ alkynyl, C₁-C₂₃ alkynyl, C₁-C₂₂ alkynyl, C₁-C₂₁ alkynyl, C₁-C₂₀ alkynyl, C₁-C₁₉ alkynyl, C₁-C₁₈ alkynyl, C₁-C₁₇ alkynyl, C₁-C₁₆ alkynyl, C₁-C₁₅ alkynyl, C₁-C₁₄ alkynyl, C₁-C₁₃ alkynyl, C₁-C₁₂ alkynyl, C₁-C₁₁ alkynyl, C₁-C₁₀ alkynyl, a C₁-C₉ alkynyl, a C₁-C₈ alkynyl, a C₁-C₇ alkynyl, a C₁-C₆ alkynyl, a C₁-C₅ alkynyl, a C₁-C₄ alkynyl, a C₁-C₃ alkynyl, a C₁-C₂ alkynyl, a C₂-C₃₀ alkynyl, a C₃-C₃₀ alkynyl, a C₄-C₃₀ alkynyl, a C₅-C₃₀ alkynyl, a C₆-C₃₀ alkynyl, a C₇-C₃₀ alkynyl, a C₈-C₃₀ alkynyl, a C₉-C₃₀ alkynyl, a C₁₀-C₃₀ alkynyl, a C₁₁-C₃₀ alkynyl, a C₁₂-C₃₀ alkynyl, a C₁₃-C₃₀ alkynyl, a C₁₄-C₃₀ alkynyl, a C₁₅-C₃₀ alkynyl, a C₁₆-C₃₀ alkynyl, a C₁₇-C₃₀ alkynyl, a C₁₈-C₃₀ alkynyl, a C₁₉-C₃₀ alkynyl, a C₂₀-C₃₀ alkynyl, a C₂₁-C₃₀ alkynyl, a C₂₂-C₃₀ alkynyl, a C₂₃-C₃₀ alkynyl, a C₂₄-C₃₀ alkynyl, a C₂₅-C₃₀ alkynyl, a C₂₆-C₃₀ alkynyl, a C₂₇-C₃₀ alkynyl, a C₂₈-C₃₀ alkynyl, a C₂₉-C₃₀ alkynyl, a C₂-C₁₀ alkynyl, a C₃-C₁₀ alkynyl, a C₄-C₁₀ alkynyl, a C₅-C₁₀ alkynyl, a C₆-C₁₀ alkynyl, a C₇-C₁₀ alkynyl, a C₈-C₁₀ alkynyl, a C₂-C₉ alkynyl, a C₂-C₈ alkynyl, a C₂-C₇ alkynyl, a C₂-C₆ alkynyl, a C₂-C₅ alkynyl, a C₃-C₅ alkynyl, or any combination thereof. Examples of alkynyl groups include, without limitation, at least one of ethynyl, propynyl, n-butynyl, n-pentynyl, 3-methyl-1-butynyl, n-hexynyl, methyl-pentynyl, or any combination thereof.

As used herein, the term “cycloalkyl” refers to a non-aromatic carbocyclic ring having from 3 to 8 carbon atoms in the ring. The term includes a monocyclic non-aromatic carbocyclic ring and a polycyclic non-aromatic carbocyclic ring. The term “monocyclic,” when used as a modifier, refers to a cycloalkyl having a single cyclic ring structure. The term “polycyclic,” when used as a modifier, refers to a cycloalkyl having more than one cyclic ring structure, which may be fused, bridged, spiro, or otherwise bonded ring structures. For example, two or more cycloalkyls may be fused, bridged, or fused and bridged to obtain the polycyclic non-aromatic carbocyclic ring. In some embodiments, the cycloalkyl may comprise, consist of, or consist essentially of, or may be selected from the group consisting of, at least one of cyclopropyl, cyclobutyl, cyclopentyl, cyclohexyl, cycloheptyl, cyclooctyl, or any combination thereof.

As used herein, the term “aryl” refers to a monocyclic or polycyclic aromatic hydrocarbon. The number of carbon atoms of the aryl may be in a range of 5 carbon atoms to 100 carbon atoms. In some embodiments, the aryl has 5 to 20 carbon atoms. For example, in some embodiments, the aryl has 6 to 8 carbon atoms, 6 to 10 carbon atoms, 6 to 12 carbon atoms, 6 to 15 carbon atoms, or 6 to 20 carbon atoms. The term “monocyclic,” when used as a modifier, refers to an aryl having a single aromatic ring structure. The term “polycyclic,” when used as a modifier, refers to an aryl having more than one aromatic ring structure, which may be fused, bridged, spiro, or otherwise bonded ring structures. In some embodiments, the aryl is —C₆H₅.

Non-limiting examples of aryls include, without limitation, at least one of benzene, toluene, xylene (e.g., o-xylene, m-xylene, p-xylene), t-butyltoluene (e.g., o-t-butyltoluene, m-t-butyltoluene, p-t-butyltoluene), ethylmethylbenzene (e.g., 1-ethyl-4-methylbenzene, 1-ethyl-3-methylbenzene), 1-isopropyl-4-methylbenzene, 1-t-butyl-4-methylbenzene, mesitylene, pseudocumene, durene, methylbenzene, dimethylbenzene, trimethylbenzene, ethylbenzene, diethylbenzene (e.g., 1,4-diethylbenzene), triethylbenzene, propylbenzene, butylbenzene, iso-butylbenzene, sec-butylbenzene, t-butylbenzene, hexylbenzene, styrene, naphthalene, anthracene, phenanthrene, biphenyl, terphenyl, methylnaphthalene, biphenylene, dimethylnaphthalene, methylanthracene, 4,4′-dimethylbiphenyl, bibenzyl, diphenylmethane, any isomer thereof, or any combination thereof, and the like.

As used herein, the term “halide” refers to a —Cl, —Br, —I, or —F.

As used herein, the term “contacting” refers to bringing two or more components into immediate or close proximity, or into direct contact.

Some embodiments relate to precursors and related methods. At least some of these embodiments relate to precursors useful in the fabrication of microelectronic devices, including semiconductor devices, and the like. For example, the precursors can be used to form aluminum-containing films by one or more deposition processes. Examples of aluminum-containing films include, for example and without limitation, at least one of aluminum oxide (e.g., Al₂O₃), aluminum nitride (e.g., AlN), or any combination thereof, among others. Examples of deposition processes include, without limitation, at least one of a chemical vapor deposition (CVD) process, a digital or pulsed chemical vapor deposition process, a plasma-enhanced cyclical chemical vapor deposition process (PECCVD), a flowable chemical vapor deposition process (FCVD), an atomic layer deposition (ALD) process, a thermal atomic layer deposition, a plasma-enhanced atomic layer deposition (PEALD) process, a metal organic chemical vapor deposition (MOCVD) process, a plasma-enhanced chemical vapor deposition (PECVD) process, or any combination thereof. In some embodiments, the precursors disclosed herein are useful for area selective deposition.

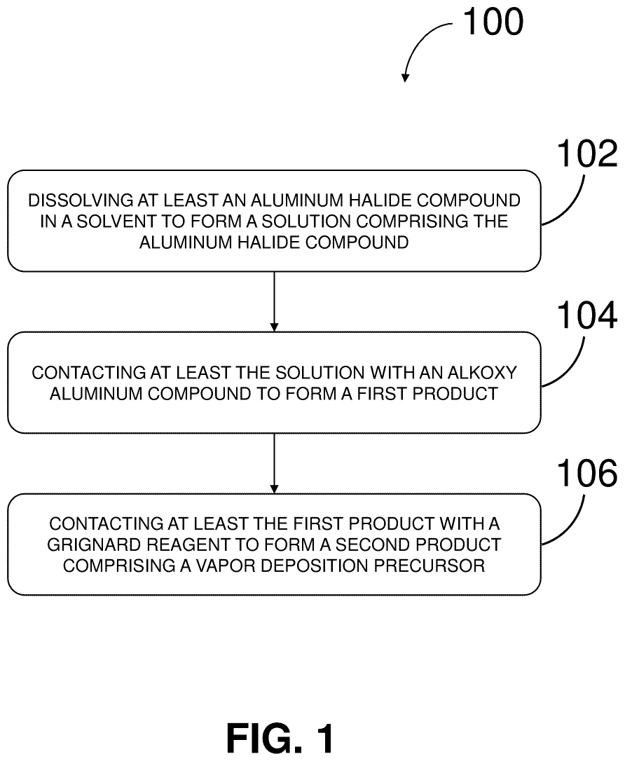

FIG. 1 is a flowchart of a method 100 for synthesizing a precursor, according to some embodiments. As shown in FIG. 1, the method 100 comprises one or more of the following steps: dissolving 102 at least an aluminum halide compound in a solvent to form a solution comprising the aluminum halide compound; contacting 104 at least the solution with an alkoxy aluminum compound to form a first product; and contacting 106 at least the first product with a Grignard reagent to form a second product comprising a vapor deposition precursor.

At step 102, the method comprises dissolving at least an aluminum halide compound in a solvent to form a solution comprising the aluminum halide compound.

In some embodiments, the dissolving comprises contacting the aluminum halide compound with the solvent. In some embodiments, the dissolving comprises bringing the aluminum halide compound and the solvent into immediate or close proximity. In some embodiments, the dissolving comprises bringing the aluminum halide compound and the solvent into direct physical contact. In some embodiments, the dissolving comprises adding the aluminum halide compound to the solvent. In some embodiments, the dissolving comprises adding the solvent to the aluminum halide compound. In some embodiments, the dissolving comprises heating to a temperature sufficient to dissolve the aluminum halide compound in the solvent. In some embodiments, the dissolving comprises mixing the solution comprising the aluminum halide compound and the solvent. In some embodiments, the dissolving comprises agitating the solution comprising the aluminum halide compound and the solvent. In some embodiments, the dissolving comprises stirring the solution comprising the aluminum halide compound and the solvent.

In some embodiments, the aluminum halide compound comprises at least one of an aluminum bromide, an aluminum chloride, an aluminum fluoride, an aluminum iodide, or any combination thereof. In some embodiments, the aluminum halide compound comprises an aluminum trihalide. In some embodiments, the aluminum halide compound comprises an aluminum tribromide (AlBr₃). In some embodiments, the aluminum halide compound comprises an aluminum trichloride (AlCl₃). In some embodiments, the aluminum halide compound comprises an aluminum trifluoride (AlF₃). In some embodiments, the aluminum halide compound comprises an aluminum triiodide (AlI₃). In some embodiments, the aluminum halide compound comprises at least one of AlCl₃, AlBr₃, AlF₃, AlI₃, or any combination thereof. In some embodiments, at least two of the halides of the aluminum halide compound are different.

In some embodiments, the aluminum halide compound comprises a compound of the formula:

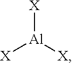

where each X is independently a halide.

In some embodiments, the solvent comprises a solvent sufficient to dissolve the aluminum halide compound. In some embodiments, the solvent comprises an ether solvent. For example, in some embodiments, the solvent comprises at least one of a tetrahydrofuran (THF), a diethyl ether, a dimethyl ether (DME), a dioxane, a diisopropyl ether, a dimethoxyethane, an ethyl tert-butyl ether, a methyl tert-butyl ether, a cylopentyl methyl ether, or any combination thereof.

In some embodiments, the solution comprises at least one of the aluminum halide compound, the solvent, or any combination thereof. It will be appreciated that, when the aluminum halide compound is present in the solvent and/or the solution, the aluminum halide compound may exist in at least one of an undissolved form, a dissolved form, or any combination thereof, such as, for example and without limitation, a compound form, an ionic form, among others. It will further be appreciated that, unless otherwise provided herein, the term aluminum halide compound refers to and includes these other forms as appropriate. This extends to other compounds disclosed herein, when present in a solution and/or a solvent.

In some embodiments, the solution comprises 0.1% to 99% by weight of the aluminum halide compound based on a total weight of the solution. For example, in some embodiments, the solution comprises 0.1% to 90%, 0.1% to 80%, 0.1% to 70%, 0.1% to 60%, 0.1% to 50%, 0.1% to 40%, 0.1% to 30%, 0.1% to 20%, 0.1% to 15%, 0.1% to 10%, 0.1% to 5%, 0.1% to 4%, 0.1% to 3%, 0.1% to 2%, 0.1% to 1%, 10% to 99%, 20% to 99%, 30% to 99%, 40% to 99%, 50% to 99%, 60% to 99%, 70% to 99%, 80% to 99%, or 90% to 99%, by weight of the aluminum halide compound based on the total weight of the solution.

At step 104, the method comprises contacting at least the solution with an alkoxy aluminum compound to form a first product.

In some embodiments, the contacting comprises bringing the solution and the alkoxy aluminum compound into close or immediate proximity. In some embodiments, the contacting comprises bringing the solution and the alkoxy aluminum compound into direct physical contact. In some embodiments, the contacting comprises bringing the aluminum halide compound and the alkoxy aluminum compound into close or immediate proximity. In some embodiments, the contacting comprises bringing the aluminum halide compound and the alkoxy aluminum compound into direct physical contact. In some embodiments, the contacting comprises reacting the aluminum halide compound and the alkoxy aluminum compound. In some embodiments, the contacting comprises stirring the aluminum halide compound and the alkoxy aluminum compound. In some embodiments, the contacting comprises mixing the aluminum halide compound and the alkoxy aluminum compound. In some embodiments, the contacting comprises agitating the aluminum halide compound and the alkoxy aluminum compound. In some embodiments, the contacting comprises adding the aluminum halide compound and the alkoxy aluminum compound to a reaction vessel (e.g., a flask, a vial, a beaker, etc.). In some embodiments, the contacting comprises combining the aluminum halide compound and the alkoxy aluminum compound in a reaction vessel. In some embodiments, the aluminum halide compound and the alkoxy aluminum compound are contacted sequentially, in any order. In some embodiments, the aluminum halide compound and the alkoxy aluminum compound are contacted substantially simultaneously or simultaneously.

In some embodiments, the alkoxy aluminum compound comprises a trialkoxy aluminum compound. In some embodiments, the alkoxy aluminum compound comprises a compound of the formula:

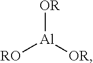

where each R is independently an alkyl.

In some embodiments, each R is the same. In some embodiments, at least two of the Rs are different. In some embodiments, each R is different.

In some embodiments, the alkyl is a substituted alkyl. In some embodiments, the alkyl is substituted with at least one of an alkenyl, an alkynyl, a cycloalkyl, an aryl, or any combination thereof.

In some embodiments, the first product comprises a compound of the formula:

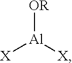

where:
each X is independently a halide; and
R is an alkyl.

In some embodiments, each X is the same. In some embodiments, each X is different.

In some embodiments, the alkyl is a substituted alkyl. In some embodiments, the alkyl is substituted with at least one of an alkenyl, an alkynyl, a cycloalkyl, or any combination thereof.

In some embodiments, X is Cl and R is a C₁-C₁₀ alkyl. In some embodiments, X is C and R is a C₁-C₉ alkyl. In some embodiments, X is Cl and R is a C₁-C₈ alkyl. In some embodiments, X is C and R is a C₁-C₇ alkyl. In some embodiments, X is C and R is a C₁-C₆ alkyl. In some embodiments, X is Cl and R is a C₁-C₅ alkyl. In some embodiments, X is Cl and R is a C₁-C₄alkyl. In some embodiments, X is Cl and R is a C₁-C₃ alkyl. In some embodiments, X is C and R is a C₁-C₂ alkyl. In some embodiments, the alkyl is substituted as described herein.

In some embodiments, X is Br and R is a C₁-C₁₀ alkyl. In some embodiments, X is Br and R is a C₁-C₉ alkyl. In some embodiments, X is Br and R is a C₁-C₈ alkyl. In some embodiments, X is Br and R is a C₁-C₇ alkyl. In some embodiments, X is Br and R is a C₁-C₆ alkyl. In some embodiments, X is Br and R is a C₁-C₅ alkyl. In some embodiments, X is Br and R is a C₁-C₄ alkyl. In some embodiments, X is Br and R is a C₁-C₃ alkyl. In some embodiments, X is Brand R is a C₁-C₂ alkyl. In some embodiments, the alkyl is substituted as described herein.

In some embodiments, X is F and R is a C₁-C₁₀ alkyl. In some embodiments, X is F and R is a C₁-C₉ alkyl. In some embodiments, X is F and R is a C₁-C₈ alkyl. In some embodiments, X is F and R is a C₁-C₇ alkyl. In some embodiments, X is F and R is a C₁-C₆ alkyl. In some embodiments, X is F and R is a C₁-C₅alkyl. In some embodiments, X is F and R is a C₁-C₄ alkyl. In some embodiments, X is F and R is a C₁-C₃ alkyl. In some embodiments, X is F and R is a C₁-C₂alkyl. In some embodiments, the alkyl is substituted as described herein.

In some embodiments, X is I and R is a C₁-C₁₀ alkyl. In some embodiments, X is I and R is a C₁-C₉ alkyl. In some embodiments, X is I and R is a C₁-C₈ alkyl. In some embodiments, X is I and R is a C₁-C₇ alkyl. In some embodiments, X is I and R is a C₁-C₆ alkyl. In some embodiments, X is I and R is a C₁-C₅ alkyl. In some embodiments, X is I and R is a C₁-C₄ alkyl. In some embodiments, X is I and R is a C₁-C₃ alkyl. In some embodiments, X is I and R is a C₁-C₂alkyl. In some embodiments, the alkyl is substituted as described herein.

At step 106, the method comprises contacting at least the first product with a Grignard reagent to form a second product comprising a vapor deposition precursor.

In some embodiments, the contacting comprises bringing the first product and the Grignard reagent into close or immediate proximity. In some embodiments, the contacting comprises bringing the first product and the Grignard reagent into direct physical contact. In some embodiments, the contacting comprises reacting the first product and the Grignard reagent. In some embodiments, the contacting comprises stirring the first product and the Grignard reagent. In some embodiments, the contacting comprises mixing the first product and the Grignard reagent. In some embodiments, the contacting comprises agitating the first product and the Grignard reagent. In some embodiments, the contacting comprises adding the first product and the Grignard reagent to a reaction vessel (e.g., a flask, a vial, a beaker, etc.). In some embodiments, the contacting comprises combining the first product and the Grignard reagent in a reaction vessel. In some embodiments, the first product and the Grignard reagent are contacted sequentially, in any order. In some embodiments, the first product and the Grignard reagent are contacted substantially simultaneously or simultaneously. In some embodiments, the Grignard reagent is present in a solvent, such as, for example and without limitation, any one or more of the solvents disclosed herein, including ether solvents, among others.

In some embodiments, the Grignard reagent comprises a compound of the formula:

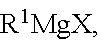

where:
R¹ is an alkyl, an alkenyl, an alkyne, an aryl, or a cycloalkyl; and
X is a halide.

In some embodiments, the alkyl is a substituted alkyl. In some embodiments, the alkyl is substituted with at least one of an alkenyl, an alkynyl, a cycloalkyl, an aryl, or any combination thereof.

In some embodiments, X is C and R¹ is a C₁-C₁₀ alkyl. In some embodiments, X is C and R¹ is a C₁-C₉ alkyl. In some embodiments, X is C and R¹ is a C₁-C₈ alkyl. In some embodiments, X is C and R¹ is a C₁-C₇alkyl. In some embodiments, X is Cl and R¹ is a C₁-C₆ alkyl. In some embodiments, X is Cl and R¹ is a C₁-C₅ alkyl. In some embodiments, X is Cl and R¹ is a C₁-C₄ alkyl. In some embodiments, X is Cl and R¹ is a C₁-C₃alkyl. In some embodiments, X is Cl and R¹ is a C₁-C₂alkyl. In some embodiments, the alkyl is substituted as described herein.

In some embodiments, X is Brand R¹ is a C₁-C₁₀ alkyl. In some embodiments, X is Br and R¹ is a C₁-C₉ alkyl. In some embodiments, X is Br and R¹ is a C₁-C₈ alkyl. In some embodiments, X is Br and R¹ is a C₁-C₇ alkyl. In some embodiments, X is Br and R¹ is a C₁-C₆ alkyl. In some embodiments, X is Br and R¹ is a C₁-C₅ alkyl. In some embodiments, X is Br and R¹ is a C₁-C₄ alkyl. In some embodiments, X is Br and R¹ is a C₁-C₃alkyl. In some embodiments, X is Brand R¹ is a C₁-C₂ alkyl. In some embodiments, the alkyl is substituted as described herein.

In some embodiments, X is I and R¹ is a C₁-C₁₀ alkyl. In some embodiments, X is I and R¹ is a C₁-C₉ alkyl. In some embodiments, X is I and R¹ is a C₁-C₈ alkyl. In some embodiments, X is I and R¹ is a C₁-C₇alkyl. In some embodiments, X is I and R¹ is a C₁-C₆ alkyl. In some embodiments, X is I and R¹ is a C₁-C₅ alkyl. In some embodiments, X is I and R¹ is a C₁-C₄ alkyl. In some embodiments, X is I and R¹ is a C₁-C₃ alkyl. In some embodiments, X is I and R¹ is a C₁-C₂alkyl. In some embodiments, the alkyl is substituted as described herein.

In some embodiments, the second product comprises the vapor deposition precursor. In some embodiments, the vapor deposition precursor comprises a dialkyl aluminum alkoxide compound. In some embodiments, the vapor deposition precursor comprises a compound of the formula:

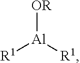

where:
R is an alkyl; and
R¹ is an alkyl, an alkenyl, an alkyne, an aryl, or a cycloalkyl.

In some embodiments, R and R¹ are different. In some embodiments, R and at least one R¹ are different. In some embodiments, R and both R¹ are different. In some embodiments, each R¹ is the same. In some embodiments, each R¹ is different.

In some embodiments, each R¹ is independently an alkyl and R is an alkyl. In some embodiments, each R¹ is independently an alkyl and R is a substituted alkyl.

In some embodiments, R¹ is a C₁-C₄ alkyl and R is a C₁-C₁₀ alkyl. In some embodiments, R¹ is a C₁-C₄ alkyl and R is a C₁-C₉ alkyl. In some embodiments, R¹ is a C₁-C₄ alkyl and R is a C₁-C₈ alkyl. In some embodiments, R¹ is a C₁-C₄ alkyl and R is a C₁-C₇ alkyl. In some embodiments, R¹ is a C₁-C₄ alkyl and R is a C₁-C₆ alkyl. In some embodiments, R¹ is a C₁-C₄ alkyl and R is a C₁-C₅ alkyl. In some embodiments, R¹ is a C₁-C₄ alkyl and R is a C₁-C₄ alkyl. In some embodiments, R¹ is a C₁-C₄ alkyl and R is a C₁-C₃ alkyl. In some embodiments, R¹ is a C₁-C₄ alkyl and R is a C₁-C₂ alkyl. In some embodiments, the alkyl is substituted as described herein.

In some embodiments, R¹ is a C₁-C₃ alkyl and R is a C₁-C₁₀ alkyl. In some embodiments, R¹ is a C₁-C₃ alkyl and R is a C₁-C₉ alkyl. In some embodiments, R¹ is a C₁-C₃ alkyl and R is a C₁-C₈ alkyl. In some embodiments, R¹ is a C₁-C₃ alkyl and R is a C₁-C₇ alkyl. In some embodiments, R¹ is a C₁-C₃ alkyl and R is a C₁-C₆ alkyl. In some embodiments, R¹ is a C₁-C₃ alkyl and R is a C₁-C₅ alkyl. In some embodiments, R¹ is a C₁-C₃ alkyl and R is a C₁-C₄ alkyl. In some embodiments, R¹ is a C₁-C₃ alkyl and R is a C₁-C₃ alkyl. In some embodiments, R¹ is a C₁-C₃ alkyl and R is a C₁-C₂ alkyl. In some embodiments, the alkyl is substituted as described herein.

In some embodiments, R¹ is a C₁-C₂ alkyl and R is a C₁-C₁₀ alkyl. In some embodiments, R¹ is a C₁-C₂ alkyl and R is a C₁-C₉ alkyl. In some embodiments, R¹ is a C₁-C₂ alkyl and R is a C₁-C₈ alkyl. In some embodiments, R¹ is a C₁-C₂ alkyl and R is a C₁-C₇ alkyl. In some embodiments, R¹ is a C₁-C₂ alkyl and R is a C₁-C₆ alkyl. In some embodiments, R¹ is a C₁-C₂ alkyl and R is a C₁-C₅ alkyl. In some embodiments, R¹ is a C₁-C₂ alkyl and R is a C₁-C₄ alkyl. In some embodiments, R¹ is a C₁-C₂ alkyl and R is a C₁-C₃ alkyl. In some embodiments, R¹ is a C₁-C₂ alkyl and R is a C₁-C₂ alkyl. In some embodiments, the alkyl is substituted as described herein.

In some embodiments, the method does not comprise a pyrophoric compound. In some embodiments, the vapor deposition precursor is formed without use of a pyrophoric compound. In some embodiments, the vapor deposition precursor is formed without use of a trialkyl aluminum compound. In some embodiments, the vapor deposition precursor is formed without use of at least one of a trimethyl aluminum compound, a dimethyl aluminum chloride compound, a methyl lithium compound, or any combination thereof. In some embodiments, the pyrophoric compound comprises a trialkyl aluminum compound. In some embodiments, the pyrophoric compound comprises at least one of a trimethyl aluminum compound, a dimethyl aluminum chloride compound, a methyl lithium compound, or any combination thereof. In some embodiments, the method does not comprise a step comprising a pyrophoric compound.

In some embodiments, the diallyl aluminum alkoxide compound is present as a liquid. In some embodiments, the diallyl aluminum alkoxide compound is dissolved in a solvent. In some embodiments, the diallyl aluminum alkoxide compound is present as a solid. In some embodiments, the diallyl aluminum alkoxide compound is capable of being separated by at least one of precipitation, distillation, filtration, or any combination thereof, among others. In some embodiments, the diallyl aluminum alkoxide compound is vaporizable.

In some embodiments, a boiling point of the solvent is at least 1% greater than a boiling point of the vapor deposition precursor. In some embodiments, a boiling point of the solvent is at least 1%, at least 10%, at least 20%, at least 30%, at least 40%, at least 50%, at least 60%, at least 70%, at least 80%, or at least 90% greater than a boiling point of the vapor deposition precursor.

Some embodiments relate to a composition. In some embodiments, the composition comprises a precursor. In some embodiments, the composition comprises a vapor deposition precursor. In some embodiments, the composition comprises a vapor deposition precursor formed according to the methods disclosed herein. In some embodiments, the vapor deposition precursor comprises a dialkyl aluminum alkoxide compound. In some embodiments, the dialkyl aluminum alkoxide compound is a reaction product of an aluminum halide compound, an alkoxy aluminum compound, and a Grignard reagent. In some embodiments, the dialkyl aluminum alkoxide compound has the characteristics defined by the following process step(s): contacting an aluminum halide compound, an alkoxy aluminum compound, and a Grignard reagent to form the vapor deposition precursor. It will be appreciated that the dialkyl aluminum alkoxide compound can have characteristics defined by any one or more of the methods disclosed herein; however, for simplicity, the methods disclosed herein are not repeated here.

In some embodiments, the vapor deposition precursor comprises a compound of the formula:

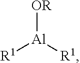

where:
R is an alkyl; and
R¹ is an alkyl.

In some embodiments, R and R¹ are different. In some embodiments, R and at least one R¹ are different. In some embodiments, R and both R¹ are different. In some embodiments, each R¹ is the same. In some embodiments, each R¹ is different.

In some embodiments, each R¹ is independently an alkyl and R is an alkyl. In some embodiments, each R¹ is independently an alkyl and R is a substituted alkyl.

In some embodiments, R¹ is a C₁-C₄ alkyl and R is a C₁-C₁₀ alkyl. In some embodiments, R¹ is a C₁-C₄ alkyl and R is a C₁-C₅ alkyl. In some embodiments, R¹ is a C₁-C₄ alkyl and R is a C₁-C₈ alkyl. In some embodiments, R¹ is a C₁-C₄ alkyl and R is a C₁-C₇ alkyl. In some embodiments, R¹ is a C₁-C₄ alkyl and R is a C₁-C₆ alkyl. In some embodiments, R¹ is a C₁-C₄ alkyl and R is a C₁-C₅ alkyl. In some embodiments, R¹ is a C₁-C₄ alkyl and R is a C₁-C₄ alkyl. In some embodiments, R¹ is a C₁-C₄ alkyl and R is a C₁-C₃ alkyl. In some embodiments, R¹ is a C₁-C₄ alkyl and R is a C₁-C₂ alkyl. In some embodiments, the alkyl is substituted as described herein.

In some embodiments, R¹ is a C₁-C₃ alkyl and R is a C₁-C₁₀ alkyl. In some embodiments, R¹ is a C₁-C₃ alkyl and R is a C₁-C₉ alkyl. In some embodiments, R¹ is a C₁-C₃ alkyl and R is a C₁-C₈ alkyl. In some embodiments, R¹ is a C₁-C₃ alkyl and R is a C₁-C₇ alkyl. In some embodiments, R¹ is a C₁-C₃ alkyl and R is a C₁-C₆ alkyl. In some embodiments, R¹ is a C₁-C₃ alkyl and R is a C₁-C₅ alkyl. In some embodiments, R¹ is a C₁-C₃ alkyl and R is a C₁-C₄ alkyl. In some embodiments, R¹ is a C₁-C₃ alkyl and R is a C₁-C₃ alkyl. In some embodiments, R¹ is a C₁-C₃ alkyl and R is a C₁-C₂ alkyl. In some embodiments, the alkyl is substituted as described herein.

In some embodiments, R¹ is a C₁-C₂ alkyl and R is a C₁-C₁₀ alkyl. In some embodiments, R¹ is a C₁-C₂ alkyl and R is a C₁-C₉ alkyl. In some embodiments, R¹ is a C₁-C₂ alkyl and R is a C₁-C₈ alkyl. In some embodiments, R¹ is a C₁-C₂ alkyl and R is a C₁-C₇ alkyl. In some embodiments, R¹ is a C₁-C₂ alkyl and R is a C₁-C₆ alkyl. In some embodiments, R¹ is a C₁-C₂ alkyl and R is a C₁-C₅ alkyl. In some embodiments, R¹ is a C₁-C₂ alkyl and R is a C₁-C₄ alkyl. In some embodiments, R¹ is a C₁-C₂ alkyl and R is a C₁-C₃ alkyl. In some embodiments, R¹ is a C₁-C₂ alkyl and R is a C₁-C₂ alkyl. In some embodiments, the alkyl is substituted as described herein.

In some embodiments, the composition comprises at least 90% by weight of the vapor deposition precursor based on a total weight of the compound. In some embodiments, the composition comprises 90% to 99.9995% by weight of the vapor deposition precursor based on total weight of the composition, or any range or subrange between 90% and 99.9995%. For example, in some embodiments, the composition comprises 90% to 99.9995%, 91% to 99.9995%, 92% to 99.9995%, 93% to 99.9995%, 94% to 99.9995%, 95% to 99.9995%, 96% to 99.9995%, 97% to 99.9995%, 98% to 99.9995%, 99% to 99.9995%, 99.9% to 99.9995%, 99.99% to 99.9995%, or 99.999% to 99.9995%, by weight of the vapor deposition precursor based on total weight of the composition.

In some embodiments, the composition comprises less than 5% by weight of a pyrophoric compound based on the total weight of the composition. In some embodiments, the composition comprises less than 4% by weight of a pyrophoric compound based on the total weight of the composition. In some embodiments, the composition comprises less than 3% by weight of a pyrophoric compound based on the total weight of the composition. In some embodiments, the composition comprises less than 2% by weight of a pyrophoric compound based on the total weight of the composition. In some embodiments, the composition comprises less than 1% by weight of a pyrophoric compound based on the total weight of the composition. In some embodiments, the composition comprises less than 0.5% by weight of a pyrophoric compound based on the total weight of the composition. In some embodiments, the composition comprises less than 0.1% by weight of a pyrophoric compound based on the total weight of the composition. In some embodiments, the composition comprises less than 0.01% by weight of a pyrophoric compound based on the total weight of the composition. In some embodiments, the composition comprises less than 0.001% by weight of a pyrophoric compound based on the total weight of the composition. In some embodiments, the composition does not comprise a pyrophoric compound.

In some embodiments, the composition comprises 0.001% to 5% by weight of a pyrophoric compound based on the total weight of the composition, or any range or subrange between 0.001% and 5%. For example, in some embodiments, the composition comprises 0.001% to 4%, 0.001% to 3%, 0.001% to 2%, 0.001% to 1%, 0.001% to 0.1%, 0.001% to 0.01%, 0.01% to 5%, 0.1% to 5%, 1% to 5%, 2% to 5%, 3% to 5%, or 4% to 5% by weight of a pyrophoric compound based on the total weight of the composition. The pyrophoric compound may comprise any one or more of the pyrophoric compounds disclosed herein. Non-limiting examples of pyrophoric compounds include, for example and without limitation, at least one of trimethyl aluminum, dimethyl aluminum chloride, methyl lithium, or any combination thereof. It will be appreciated that the pyrophoric compound may include other types of pyrophoric compounds, without departing from the scope of this disclosure.

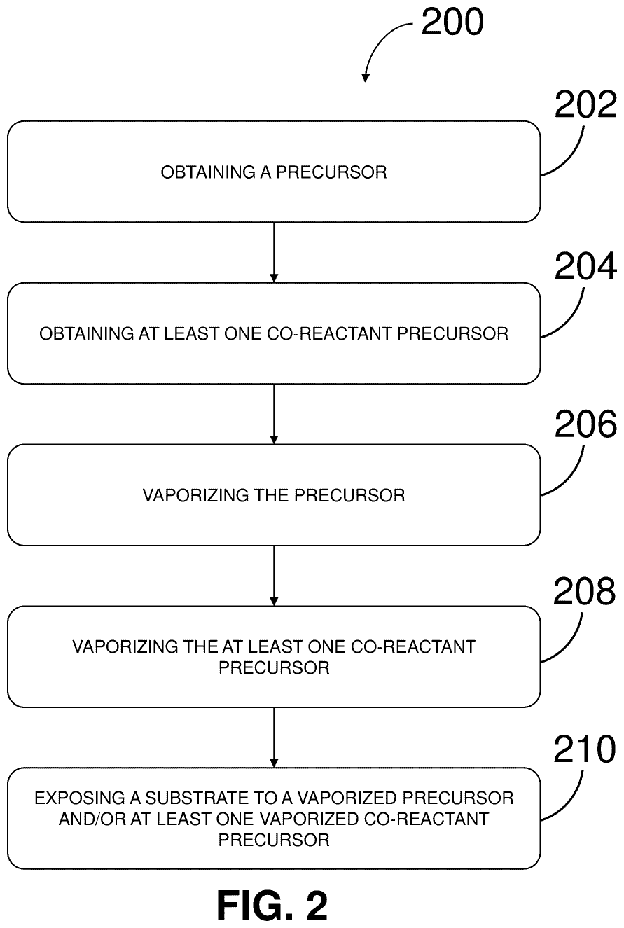

FIG. 2 is a flowchart of a method for making a film 200, according to some embodiments. As shown in FIG. 2, the method for making a film 200 may comprise one or more of the following steps: obtaining 202 a precursor, obtaining 204 at least one co-reactant precursor, vaporizing 206 the precursor to obtain a vaporized precursor, vaporizing 208 the at least one co-reactant precursor to obtain at least one vaporized co-reactant precursor, exposing 210, under vapor deposition conditions, a substrate to at least one of the vaporized precursor, the at least one vaporized co-reactant precursor, or any combination thereof, to form a film on the substrate.

At step 202, in some embodiments, the method comprises obtaining a precursor. The precursor may comprise any one or more of the vapor deposition precursors disclosed herein. For example, in some embodiments, the precursor comprises an dialkyl aluminum alkoxide compound. In some embodiments, the obtaining comprises obtaining a vessel comprising the precursor. In some embodiments, the obtaining comprises obtaining a container comprising the precursor. In some embodiments, the precursor may be obtained in a container or other vessel in which the precursor is to be vaporized.

At step 204, in some embodiments, the method comprises obtaining at least one co-reactant precursor. In some embodiments, the at least one co-reactant precursor comprises at least one of an oxidizing gas, a reducing gas, a hydrocarbon, or any combination thereof. The at least one co-reactant precursor may be selected to obtain a desired film. In some embodiments, the at least one co-reactant precursor comprises at least one of N₂, H₂, NH₃, N₂H₄, CH₃HNNH₂, CH₃HNNHCH₃, NCH₃H₂, NCH₃CH₂H₂, N(CH₃)₂H, N(CH₃CH₂)₂H, N(CH₃)₃, N(CH₃CH₂)₃, Si(CH₃)₂NH, pyrazoline, pyridine, ethylene diamine, a radical thereof, or any combination thereof. In some embodiments, the at least one co-reactant precursor comprises at least one of H₂, O₂, O₃, H₂O, H₂O₂, NO, N₂O, NO₂, CO, CO₂, a carboxylic acid, an alcohol, a diol, a radical thereof, or any combination thereof. In some embodiments, the at least one co-reactant precursor comprises at least one of methane, ethane, ethylene, acetylene, or any combination thereof. The obtaining may comprise obtaining a container or other vessel comprising the at least one co-reactant precursor. In some embodiments, the at least one co-reactant precursor may be obtained in a container or other vessel in which the at least one co-reactant precursor is to be vaporized. In some embodiments, the method further comprises an inert gas, such as, for example, at least one of argon, helium, nitrogen, or any combination thereof.

At step 206, in some embodiments, the method comprises vaporizing the precursor to obtain a vaporized precursor. The vaporizing may comprise heating the precursor sufficient to obtain the vaporized precursor. In some embodiments, the vaporizing comprises heating a container comprising the precursor. In some embodiments, the vaporizing comprises heating the precursor in a deposition chamber in which the vapor deposition process is performed. In some embodiments, the vaporizing comprises heating a conduit for delivering the precursor, the vaporized precursor, or any combination thereof to, for example, a deposition chamber. In some embodiments, the vaporizing comprises operating a vapor delivery system comprising the precursor. In some embodiments, the vaporizing comprises heating to a temperature sufficient to vaporize the precursor to obtain the vaporized precursor. In some embodiments, the vaporizing comprises heating to a temperature below a decomposition temperature of at least one of the precursor, the vaporized precursor, or any combination thereof. In some embodiments, the precursor may be present in a gas phase or other vaporizable phase, in which case the step 206 is optional and not required. For example, in some embodiments, the precursor comprises the vaporized precursor.

At step 208, in some embodiments, the method comprises vaporizing the at least one co-reactant precursor to obtain the at least one vaporized co-reactant precursor. In some embodiments, the vaporizing comprises heating the at least one co-reactant precursor sufficient to obtain the at least one vaporized co-reactant precursor. In some embodiments, the vaporizing comprises heating a container comprising the at least one co-reactant precursor. In some embodiments, the vaporizing comprises heating the at least one co-reactant precursor in a deposition chamber in which the vapor deposition process is performed. In some embodiments, the vaporizing comprises heating a conduit for delivering the at least one co-reactant precursor, the at least one vaporized co-reactant precursor, or any combination thereof to, for example, a deposition chamber. In some embodiments, the vaporizing comprises operating a vapor delivery system comprising the at least one co-reactant precursor. In some embodiments, the vaporizing comprises heating to a temperature sufficient to vaporize the at least one co-reactant precursor to obtain the at least one vaporized co-reactant precursor. In some embodiments, the vaporizing comprises heating to a temperature below a decomposition temperature of at least one of the at least one co-reactant precursor, the at least one vaporized co-reactant precursor, or any combination thereof. In some embodiments, the at least one co-reactant precursor may be present in a gas phase or other vaporizable phase, in which case the step 208 is optional and not required. For example, in some embodiments, the at least one co-reactant precursor comprises the at least one vaporized co-reactant precursor.

At step 210, in some embodiments, the method comprises exposing, under vapor deposition conditions, a substrate to at least one of the vaporized precursor, the at least one vaporized co-reactant precursor, or any combination thereof, to form a film on the substrate. The exposing may be performed in any system, apparatus, device, assembly, chamber thereof, or component thereof suitable for vapor deposition processes, including, for example and without limitation, a deposition chamber, among others. In some embodiments, the exposing comprises contacting the substrate with at least one of the vaporized precursor, the at least one vaporized co-reactant precursor, or any combination thereof. The vaporized precursor and the at least one co-reactant precursor may be contacted with the substrate at the same time or at different times. For example, each of the vaporized precursor, the at least one vaporized co-reactant precursor, and the substrate may be present in the deposition chamber at the same time. That is, in some embodiments, the contacting may comprise contemporaneous contacting or simultaneous contacting of the vaporized precursor and the at least one vaporized co-reactant precursor with the substrate. Alternatively, each of the vaporized precursor and the at least one vaporized co-reactant precursor may be present in the deposition chamber at different times. That is, in some embodiments, the contacting may comprise alternate and/or sequential contacting, in one or more cycles, of the vaporized precursor with the substrate and subsequently contacting the at least one vaporized co-reactant precursor with the substrate.

The vapor deposition conditions may comprise conditions for vapor deposition processes. Examples of vapor deposition conditions include, without limitation, vapor deposition conditions for vapor deposition processes including at least one of a chemical vapor deposition (CVD) process, a digital or pulsed chemical vapor deposition process, a plasma-enhanced cyclical chemical vapor deposition process (PECCVD), a flowable chemical vapor deposition process (FCVD), an atomic layer deposition (ALD) process, a thermal atomic layer deposition, a plasma-enhanced atomic layer deposition (PEALD) process, a metal organic chemical vapor deposition (MOCVD) process, a plasma-enhanced chemical vapor deposition (PECVD) process, or any combination thereof.

The vapor deposition conditions may comprise a deposition temperature. The deposition temperature may be a temperature less than the thermal decomposition temperature of at least one of the vaporized precursor, the at least one vaporized co-reactant precursor, or any combination thereof. The deposition temperature may be sufficiently high to reduce or avoid condensation of at least one of the vaporized precursor, the at least one vaporized co-reactant precursor, or any combination thereof. In some embodiments, the substrate may be heated to the deposition temperature. In some embodiments, the chamber or other vessel in which the substrate is contacted with the vaporized precursor and the at least one vaporized co-reactant precursor is heated to the deposition temperature. In some embodiments, at least one of the vaporized precursor, the at least one vaporized co-reactant precursor, or any combination thereof may be heated to the deposition temperature.

The deposition temperature may be a temperature of 200° C. to 2500° C., or any range or subrange between 200° C. and 2500° C. In some embodiments, the deposition temperature may be a temperature of 500° C. to 700° C. For example, in some embodiments, the deposition temperature may be a temperature of 500° C. to 680° C., 500° C. to 660° C., 500° C. to 640° C., 500° C. to 620° C., 500° C. to 600° C., 500° C. to 580° C., 500° C. to 560° C., 500° C. to 540° C., 500° C. to 520° C., 520° C. to 700° C., 540° C. to 700° C., 560° C. to 700° C., 580° C. to 700° C., 600° C. to 700° C., 620° C. to 700° C., 640° C. to 700° C., 660° C. to 700° C., or 680° C. to 700° C. In other embodiments, the deposition temperature may be a temperature of greater than 200° C. to 2500° C., such as, for example and without limitation, a temperature of 400° C. to 2000, 500° C. to 2000° C., 550° C. to 2400° C., 600° C. to 2400° C., 625° C. to 2400° C., 650° C. to 2400° C., 675° C. to 2400° C., 700° C. to 2400° C., 725° C. to 2400° C., 750° C. to 2400° C., 775° C. to 2400° C., 800° C. to 2400° C., 825° C. to 2400° C., 850° C. to 2400° C., 875° C. to 2400° C., 900° C. to 2400° C., 925° C. to 2400° C., 950° C. to 2400° C., 975° C. to 2400° C., 1000° C. to 2400° C., 1025° C. to 2400° C., 1050° C. to 2400° C., 1075° C. to 2400° C., 1100° C. to 2400° C., 1200° C. to 2400° C., 1300° C. to 2400° C., 1400° C. to 2400° C., 1500° C. to 2400° C., 1600° C. to 2400° C., 1700° C. to 2400° C., 1800° C. to 2400° C., 1900° C. to 2400° C., 2000° C. to 2400° C., 2100° C. to 2400° C., 2200° C. to 2400° C., 2300° C. to 2400° C., 500° C. to 2000° C., 500° C. to 1900° C., 500° C. to 1800° C., 500° C. to 1700° C., 500° C. to 1600° C., 500° C. to 1500° C., 500° C. to 1400° C., 500° C. to 1300° C., 500° C. to 1200° C., 500° C. to 1100° C., 500° C. to 1000° C., 500° C. to 1000° C., 500° C. to 900° C., or 500° C. to 800° C.

The vapor deposition conditions may comprise a deposition pressure. In some embodiments, the deposition pressure may comprise a vapor pressure of at least one of the vaporized precursor, the at least one vaporized co-reactant precursor, or any combination thereof. In some embodiments, the deposition pressure may comprise a chamber pressure.

The deposition pressure may be a pressure of 0.001 Torr to 100 Torr, or any range or subrange between 0.001 Torr and 100 Torr. For example, in some embodiments, the deposition pressure may be a pressure of 1 Torr to 30 Torr, 1 Torr to 25 Torr, 1 Torr to 20 Torr, 1 Torr to 15 Torr, 1 Torr to 10 Torr, 5 Torr to 50 Torr, 5 Torr to 40 Torr, 5 Torr to 30 Torr, 5 Torr to 20 Torr, or 5 Torr to 15 Torr. In other embodiments, the deposition pressure may be a pressure of 1 Torr to 100 Torr, 5 Torr to 100 Torr, 10 Torr to 100 Torr, 15 Torr to 100 Torr, 20 Torr to 100 Torr, 25 Torr to 100 Torr, 30 Torr to 100 Torr, 35 Torr to 100 Torr, 40 Torr to 100 Torr, 45 Torr to 100 Torr, 50 Torr to 100 Torr, 55 Torr to 100 Torr, 60 Torr to 100 Torr, 65 Torr to 100 Torr, 70 Torr to 100 Torr, 75 Torr to 100 Torr, 80 Torr to 100 Torr, 85 Torr to 100 Torr, 90 Torr to 100 Torr, 95 Torr to 100 Torr, 1 Torr to 95 Torr, 1 Torr to 90 Torr, 1 Torr to 85 Torr, 1 Torr to 80 Torr, 1 Torr to 75 Torr, or 1 Torr to 70 Torr. In other further embodiments, the deposition pressure may be a pressure of 1 mTorr to 100 mTorr, 1 mTorr to 90 mTorr, 1 mTorr to 80 mTorr, 1 mTorr to 70 mTorr, 1 mTorr to 60 mTorr, 1 mTorr to 50 mTorr, 1 mTorr to 40 mTorr, 1 mTorr to 30 mTorr, 1 mTorr to 20 mTorr, 1 mTorr to 10 mTorr, 100 mTorr to 300 mTorr, 150 mTorr to 300 mTorr, 200 mTorr to 300 mTorr, or 150 mTorr to 250 mTorr, or 150 mTorr to 225 mTorr.

The substrate may comprise at least one of Si, Co, Cu, Al, W, WN, WC, TiN, Mo, MoC, SiO₂, W, SiN, WCN, Al₂O₃, AlN, ZrO₂, La₂O₃, TaN, RuO₂, IrO₂, Nb₂O₃, Y₂O₃, hafnium oxide, or any combination thereof.

In some embodiments, the film comprises an aluminum compound. For example, in some embodiments, the film comprises at least one of an aluminum, an aluminum oxide compound (e.g., Al₂O₃, etc.), an aluminum nitride compound, an aluminum oxynitride compound, an aluminum carbide compound, an aluminum carbonitride compound, or any combination thereof.

Some embodiments relate to a film on a substrate. In some embodiments, the film comprises any film formed according to the methods disclosed herein. In some embodiments, the film comprises any film prepared from any one or more of the precursors disclosed herein.

Any one or more of the embodiments disclosed herein shall be understood to be combinable without departing from the scope or spirit of the disclosure.

### Example 1

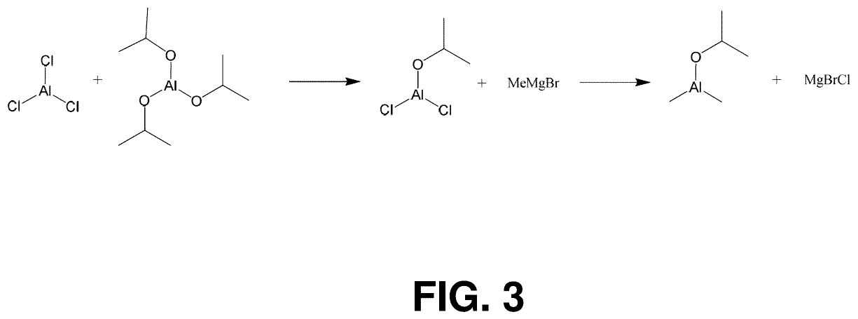

A vapor deposition precursor comprising dimethyl aluminum isopropoxide (DMAI) was formed in a one-pot synthesis (FIG. 3). To prepare the dimethyl aluminum isopropoxide, in a nitrogen filled glovebox, 20.00 g of aluminum chloride (150 mmol, 2 eq) and 50 mL of pentane were added to a 500 mL 3-neck flask equipped with a stir bar, air-cooled condenser, addition funnel, and thermocouple. 15.32 g of aluminum isopropoxide (75 mmol, 1 eq) was added to a 250 mL flask and suspended in 150 mL of diethyl ether. The aluminum isopropoxide suspension was transferred to the addition funnel and slowly added to the aluminum chloride suspension under stirring. The addition rate was monitored to keep the reaction temperature below 40° C. Once the addition was complete, the resulting reaction mixture was allowed to stir for 1 hr. The addition funnel was then charged with 150 mL of methylmagnesium bromide (3.0M in diethyl ether, 450 mmol, 6 eq). The methylmagnesium bromide solution was slowly added to the reaction mixture with the addition rate monitored to keep the reaction temperature below 40° C. Once the addition was complete, the resulting reaction mixture was allowed to stir for 16 hr. The reaction mixture was filtered to remove the precipitate, and the solvent was removed under vacuum. The product was extracted with 150 mL of pentane, filtered again, and the solvent removed under vacuum to yield a pale-yellow liquid. The crude material was purified using a short path distillation with a mantal temperature of 32° C., a head temperature of 19° C., a condenser cooled to −5° C., and a baseline pressure of 250 mTorr to yield 15.22 g (58% yield) of dimethyl aluminum isopropoxide as a clear colorless liquid. The synthesis did not involve use of any pyrophoric compounds.

¹H-NMR (400 MHz, C₆D₆, 25° C.): δ 3.83 (s, 1H, CH₃CHCH₃O—Al), δ 0.99 (d, 6H, CH₃CHCH₃O—Al), δ −0.45 (s, 6H, CH₃-AI).

### Example 2

A vapor deposition precursor comprising dimethyl aluminum sec-butoxide (DMAS) was formed in a one-pot synthesis. To prepare the dimethyl aluminum sec-butoxide, in a nitrogen filled glovebox, 20.00 g of aluminum chloride (150 mmol, 2 eq) and 50 m L of pentane were added to a 500 m L 3 neck flask equipped with a stir bar, air-cooled condenser, addition funnel, and thermocouple. 18.48 g of tri-sec-butoxyaluminum (75 mmol, 1 eq) was added to a 250 mL flask and diluted in 150 mL of diethyl ether. The aluminum isopropoxide suspension was transferred to the addition funnel and slowly added to the stirring aluminum chloride suspension. The addition rate was monitored to keep the reaction temperature below 40° C. Once the addition was complete, the resulting reaction mixture was allowed to stir for 1 hr. The addition funnel was then charged with 150 mL of methylmagnesium bromide (3.0 M in diethyl ether, 450 mmol, 6 eq). The methylmagnesium bromide solution was slowly added to the reaction mixture with the addition rate monitored to keep the reaction temperature below 40° C. Once the addition was complete, the resulting reaction mixture was allowed to stir for 16 hr. The reaction mixture was filtered to remove the precipitate, and the solvent was removed under vacuum. The product was extracted with 150 mL of pentane, filtered again, and the solvent removed under vacuum to yield a pale-yellow liquid. The crude material was purified using a short path distillation with a mantal temperature of 55° C., a head temperature of 40° C., a condenser cooled to −5° C., and a baseline pressure of 200 mTorr to yield 18.95 g (65% yield) of dimethyl aluminum sec-butoxide as a clear colorless liquid. The synthesis did not involve use of any pyrophoric compounds.

¹H-NMR (400 MHz, C₆D₆, 25° C.): δ 3.62 (sx, 1H, CH₃CHCH₂CH₃O—Al), δ 1.53-1.19 (m, 2H, CH₃CHCH₂CH₃O—Al), δ 1.02 (d, 3H, CH₃CHCH₂CH₃O—Al), δ 0.66 (t, 3H CH₃CHCH₂CH₃O—Al), δ −0.45 (s, 6H, CH₃-AI).

### ASPECTS

Various Aspects are described below. It is to be understood that any one or more of the features recited in the following Aspect(s) can be combined with any one or more other Aspect(s).
Aspect 1. A method comprising:
   contacting at least a solution comprising an aluminum halide compound with an alkoxy aluminum compound to form a first product; and
   contacting at least the first product with a Grignard reagent to form a second product comprising a vapor deposition precursor.
Aspect 2. The method according to Aspect 1, wherein the method does not comprise a pyrophoric compound.
Aspect 3. The method according to any one of Aspects 1-2, wherein the solution comprises at least one of a tetrahydrofuran (THF), a diethyl ether, a dimethyl ether (DME), a dioxane, a diisopropyl ether, a dimethoxyethane, an ethyl tert-butyl ether, a methyl tert-butyl ether, a cylopentyl methyl ether, or any combination thereof.
Aspect 4. The method according to any one of Aspects 1-3, wherein the aluminum halide compound comprises a compound of the formula:

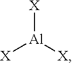

where each X is independently Cl, Br, F, or I.
Aspect 5. The method according to any one of Aspects 1-4, wherein the aluminum halide compound comprises at least one of AlCl₃, AlBr₃, AlF₃, AlI₃, or any combination thereof.
Aspect 6. The method according to any one of Aspects 1-5, wherein the alkoxy aluminum compound comprises a compound of the formula:

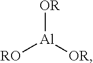

where each R is independently an alkyl.
Aspect 7. The method according to Aspect 6, wherein the alkyl is substituted with at least one of an alkenyl, an alkynyl, a cycloalkyl, an aryl, or any combination thereof.
Aspect 8. The method according to any one of Aspects 1-7, wherein the first product comprises a compound of the formula:

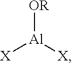

where:
   each X is independently Cl, Br, F, or I; and
   R is an alkyl.
Aspect 9. The method according to any one of Aspects 1-8, wherein the Grignard reagent comprises a compound of the formula:

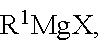

where:
   R¹ is an alkyl, an alkenyl, an alkyne, an aryl, or a cycloalkyl; and
   X is Cl, Br, F, or I.
Aspect 10. The method according to any one of Aspects 1-9, wherein the vapor deposition precursor comprises a dialkyl aluminum alkoxide compound.
Aspect 11. The method according to any one of Aspects 1-10, wherein the vapor deposition precursor comprises a compound of the formula:

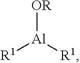

where:
   R is an alkyl; and
   R¹ is an alkyl, an alkenyl, an alkyne, an aryl, or a cycloalkyl.
Aspect 12. A method comprising:
   dissolving at least an aluminum chloride compound in a solvent to form a mixture comprising the aluminum chloride compound;
   contacting at least the mixture with an alkoxy aluminum compound to form a first product; and
   contacting at least the first product with a Grignard reagent to form a second product comprising a vapor deposition precursor.
Aspect 13. The method according to Aspect 12, wherein the method does not comprise a pyrophoric compound.
Aspect 14. The method according to any one of Aspects 12-13, wherein the solvent comprises at least one of a tetrahydrofuran (THF), a diethyl ether, a dimethyl ether (DME), a dioxane, a diisopropyl ether, a dimethoxyethane, an ethyl tert-butyl ether, a methyl tert-butyl ether, a cylopentyl methyl ether, or any combination thereof.
Aspect 15. The method according to any one of Aspects 12-14, wherein the first product comprises a compound of the formula:

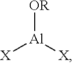

where:
   each X is independently Cl, Br, or I; and
   R is an alkyl.
Aspect 16. The method according to any one of Aspects 12-15, wherein the Grignard reagent comprises a compound of the formula:

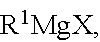

where:
   R¹ is an alkyl, an alkenyl, an alkyne, an aryl, or a cycloalkyl; and
   X is Cl, Br, or I.
Aspect 17. The method according to any one of Aspects 12-16, wherein the vapor deposition precursor comprises a compound of the formula:

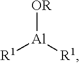

where:
   R is an alkyl; and
   R¹ is an alkyl, an alkenyl, an alkyne, an aryl, or a cycloalkyl.
Aspect 18. A composition comprising:
   at least 99% by weight of a vapor deposition precursor based on a total weight of the composition,
      wherein the vapor deposition precursor comprises a compound of the formula:

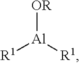

where:
R is an alkyl; and
R¹ is an alkyl, an alkenyl, an alkyne, an aryl, or a cycloalkyl.
Aspect 19. The composition according to Aspect 18, wherein the composition comprises 99.9% to 99.9995% by weight of the vapor deposition precursor based on the total weight of the composition.
Aspect 20. The composition according to Aspect 18 or 19, wherein the vapor deposition precursor comprises dimethyl aluminum isopropoxide.

What is claimed is:

1. A method comprising:
contacting at least a solution comprising an aluminum halide compound with an alkoxy aluminum compound to form a first product; and
contacting at least the first product with a Grignard reagent to form a second product comprising a vapor deposition precursor.

2. The method of claim 1, wherein the method does not comprise a pyrophoric compound.

3. The method of claim 1, wherein the solution comprises at least one of a tetrahydrofuran (THF), a diethyl ether, a dimethyl ether (DME), a dioxane, a diisopropyl ether, a dimethoxyethane, an ethyl tert-butyl ether, a methyl tert-butyl ether, a cylopentyl methyl ether, or any combination thereof.

4. The method of claim 1, wherein the aluminum halide compound comprises a compound of the formula: 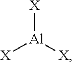
where each X is independently Cl, Br, F, or I.

5. The method of claim 1, wherein the aluminum halide compound comprises at least one of AlCl₃, AlBr₃, AlF₃, AlI₃, or any combination thereof.

6. The method of claim 1, wherein the alkoxy aluminum compound comprises a compound of the formula: 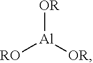
where each R is independently an alkyl.

7. The method of claim 6, wherein the alkyl is substituted with at least one of an alkenyl, an alkynyl, a cycloalkyl, an aryl, or any combination thereof.

8. The method of claim 1, wherein the first product comprises a compound of the formula: 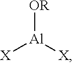
where:
each X is independently Cl, Br, F, or I; and
R is an alkyl.

9. The method of claim 1, wherein the Grignard reagent comprises a compound of the formula: 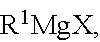
where:
R¹ is an alkyl, an alkenyl, an alkyne, an aryl, or a cycloalkyl; and
X is Cl, Br, or I.

10. The method of claim 1, wherein the vapor deposition precursor comprises a dialkyl aluminum alkoxide compound.

11. The method of claim 1, wherein the vapor deposition precursor comprises a compound of the formula: 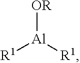
where:
R is an alkyl; and
R¹ is an alkyl, an alkenyl, an alkyne, an aryl, or a cycloalkyl.

12. A method comprising:
dissolving at least an aluminum chloride compound in a solvent to form a mixture comprising the aluminum chloride compound;
contacting at least the mixture with an alkoxy aluminum compound to form a first product; and
contacting at least the first product with a Grignard reagent to form a second product comprising a vapor deposition precursor.

13. The method of claim 12, wherein the method does not comprise a pyrophoric compound.

14. The method of claim 12, wherein the solvent comprises at least one of a tetrahydrofuran (THF), a diethyl ether, a dimethyl ether (DME), a dioxane, a diisopropyl ether, a dimethoxyethane, an ethyl tert-butyl ether, a methyl tert-butyl ether, a cylopentyl methyl ether, or any combination thereof.

15. The method of claim 12, wherein the first product comprises a compound of the formula: 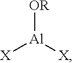
where:
each X is independently Cl, Br, F, or I; and
R is an alkyl.

16. The method of claim 12, wherein the Grignard reagent comprises a compound of the formula: 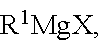
where:
R¹ is an alkyl, an alkenyl, an alkyne, an aryl, or a cycloalkyl; and
X is Cl, Br, or I.

17. The method of claim 12, wherein the vapor deposition precursor comprises a compound of the formula: 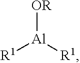
where:
R is an alkyl; and
R¹ is an alkyl, an alkenyl, an alkyne, an aryl, or a cycloalkyl.

18. A composition comprising:
at least 99% by weight of a vapor deposition precursor based on a total weight of the composition,
wherein the vapor deposition precursor comprises a compound of the formula: 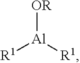
where:
R is an alkyl; and
R¹ is an alkyl, an alkenyl, an alkyne, an aryl, or a cycloalkyl.

19. The composition of claim 18, wherein the composition comprises 99.9% to 99.9995% by weight of the vapor deposition precursor based on the total weight of the composition.

20. The composition of claim 18, wherein the vapor deposition precursor comprises dimethyl aluminum isopropoxide.
